(19) United States
(12) Patent Application Publication
(10) Pub. No.: US 2007/0085331 A1
(43) Pub. Date: Apr. 19, 2007

(54) Document storing aid

(76) Inventor: Bonnie L. Mueller, Toms River, NJ (US)

Correspondence Address: MICHAEL R. PHILLIPS, P.O. BOX 1818, TOMS RIVER, NJ, 08754-1818, US

(21) Appl. No.: 11/221,307

(22) Filed: Sep. 7, 2005

(51) Int. Cl. B42D 7/00

(52) U.S. Cl. 281/45

(57) ABSTRACT

The disclosed document storing aid is a paper or plastic strip having two segments. A releasable adhesive is coated on one segment of the strip, and a series of holes are punched through another segment. The adhesive segment is assembled to an edge of a document, and the holes are adapted for being placed into a ring binder or a post binder for storing the document for future access and retrieval.

### FIELD OF THE INVENTION

The present invention relates to the field of adhesive coated paper or plastic sheet products and more particularly to adhesive coated sheet products having means for being held in a storage device.

### BACKGROUND OF THE INVENTION

Documents, by their very nature, should be preserved for future reference and stored in a manner to be easily retrieved. A popular and useful device for storing documents in an organized fashion for future retrieval is a ring binder, also known as a loose-leaf binder. To store paper sheets in a ring binder, each sheet is punched with the appropriate number of holes, e.g. 2, 3 or 5 holes, in positions to align with and slip onto the open rings. The holes are punched along the left vertical edge of the paper to match the position of the rings in the respective ring binder. Other types of storage devices are the 2 post binder and the file folder having 2 bendable metal tabs, both of which devices store paper sheets having 2 holes punched along the top edge.

The types of storage devices described above are well adapted for storing relatively informal papers. However, it is often not desirable to punch holes in more formal and important documents. The integrity of formal documents is considered compromised by punching holes for storage purposes. In addition, punching holes may destroy small portions of the text, making the document more difficult to read. Nonetheless, a ring binder or post binder can provide a simple and organized means to store the documents in unblemished condition for easy future retrieval. The present invention provides a novel aid for storing documents without damage and with easy access for retrieval.

### SUMMARY OF THE INVENTION

The invention provides a strip of flexible material that has a series of holes punched through a first segment and is coated with an adhesive on one surface of a second segment. The first and second segments are oriented parallel to the long dimension of the flexible strip. The adhesive is adapted to secure the strip releasably to a document to be stored, and the series of holes are positioned to engage rings or posts of a binder or bendable metal tabs of a file folder. The flexible strip may be applied to the front or the rear surface of the document. Alternatively, a first flexible strip is applied to the front and a second flexible strip is applied to the rear of the document with the punched holes of the two strips in matched alignment to be placed on the rings or posts for storing the document. Notations regarding the document may be written on the strip without affecting the document itself. When the document is later needed, the flexible strip is readily removed leaving the document in its original condition.

### BRIEF DESCRIPTION OF THE DRAWINGS

The present invention is best understood in conjunction with the accompanying drawing figures in which like elements are identified by similar reference numerals and wherein:

FIG. 1 is a front elevation view of the flexible strip of a first embodiment of the invention applied to the front of a document to be stored.

FIG. 2 is a rear elevation view of the flexible strip of the first embodiment showing a segment with an adhesive coating and a segment having 3 punched holes.

FIG. 3 is a rear elevation view of a flexible strip of the second embodiment showing a segment with an adhesive coating and a segment having 2 punched holes.

FIG. 4 is a perspective view of a document with a paper strip of the present invention being inserted into an open ring binder.

FIG. 5 is a front elevation view of the flexible strip of the second embodiment of the invention applied to the front of a document to be stored.

### DETAILED DESCRIPTION OF THE PREFERRED EMBODIMENTS:

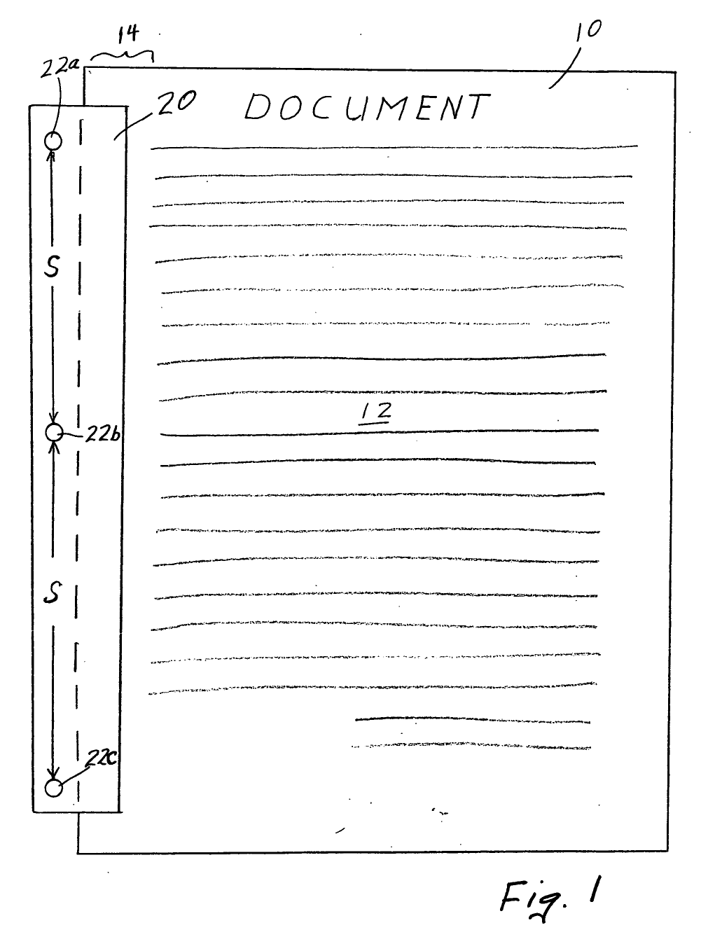

Referring now to FIG. 1, a document 10 contains a body of text 12 that covers a major portion of the face of document 10. Text 12 is surrounded by unprinted margin portions, including left margin 14. A flexible strip 20 is mounted along left margin 14 of document 10 by means of a releasable adhesive coating. Flexible strip 20 may be formed of paper, plastic or other flexible sheet material and, if formed of plastic, may be opaque or transparent. A series of 3 punched holes 22a, 22b and 22c are formed through flexible strip 20 and positioned to reside beyond the edge of document 10. A separating distance S between each pair of adjacent holes 22a, 22b and 22c locates respective holes 22a, 22b and 22c to engage rings of a ring binder. Notations may be handwritten on flexible strip 20 without directly affecting the face of document 10. The length of flexible strip 20 is equal to or less than the length of document 10.

Referring now to FIG. 2, a rear view is illustrated of flexible strip 20 with punched segment 26 and adhesive coated segment 28 shown oriented parallel to the long dimension of flexible strip 20. The relative width of punched segment 26 and adhesive coated segment 28 on the face of flexible strip 20 is left to the discretion of the manufacturer. Holes 22a, 22b and 22c are formed through punched segment 26 with a diameter D and inter-hole space S to accommodate the size and spacing of rings of a ring binder. An adhesive 24 is coated on segment 28 of flexible strip 20. Adhesive 24 is a releasable pressure sensitive adhesive that allows flexible strip 20 to be removed from document 10 (see FIG. 1) without damage thereto and reapplied multiple times. An appropriate adhesive is the type used on known releasable note paper, e.g. Post-It® Notes.

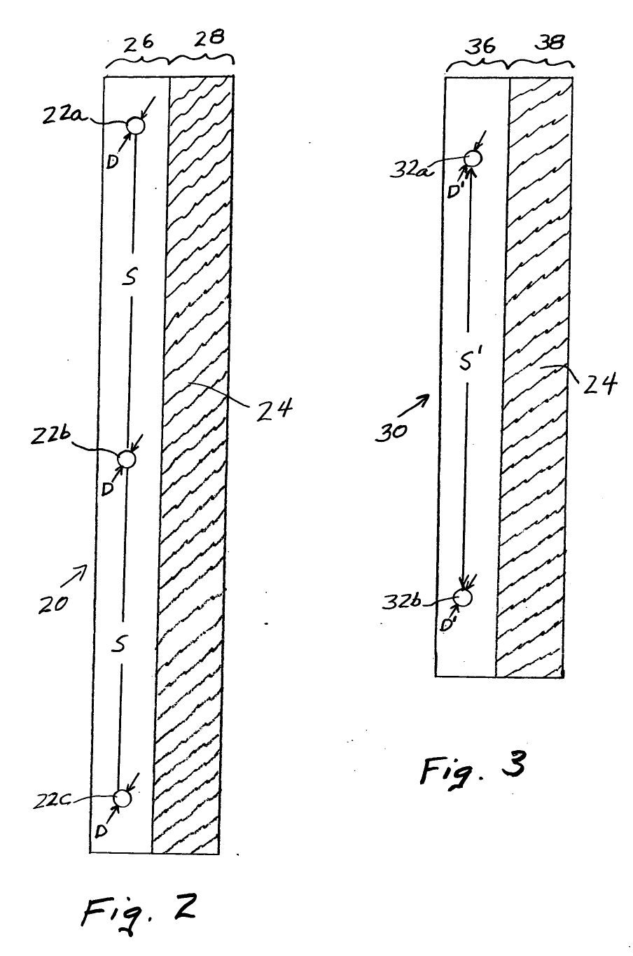

FIG. 3 shows a second embodiment of the invention flexible strip 30 that has 2 holes 32a and 32b punched through a punched segment 36. Holes 32a and 32b have a diameter D′ to accommodate either rings of a 2-hole ring binder, posts of a post binder or bendable metal tabs of a file folder. The space S′ between holes 32a and 32b is adapted according to the storage medium in which document 10 (see FIG. 1) is to be stored. An adhesive 24, described above, is applied to coated segment 38 of flexible strip 30. The length of flexible strip 30 is equal to or shorter than the length of the document to which flexible strip 30 is attached.

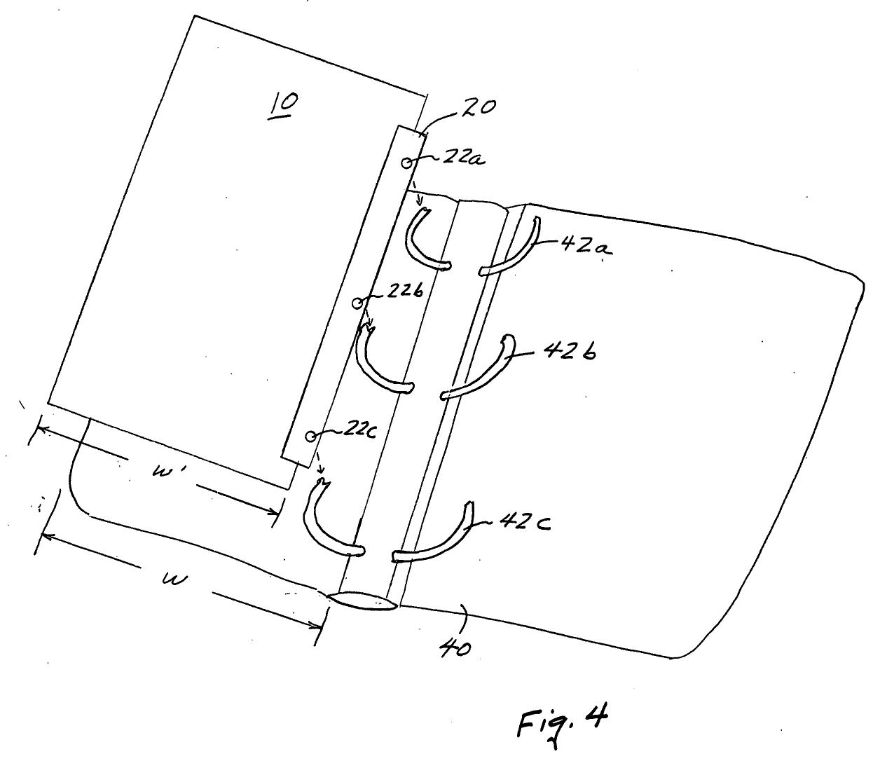

Referring now to FIG. 4, a 3-ring binder 40 is shown with rings 42a, 42b and 42c in open condition to receive a document 10 to be stored therein. A flexible strip 20 having 3 holes 22a, 22b and 22c punched through a non-adhesive portion thereof is assembled to an edge of the back surface of document 10 in a position for holes 22a, 22b and 22c to engage rings 42a, 42b and 42c. Placement of flexible strip 20 on the back surface of document 10 does not block any portion of text on the front surface of document 10. After engaging holes 22a, 22b and 22c on respective rings 42a, 42b and 42c, rings 42a, 42b and 42c are closed to store document 10 in binder 40. Typically, the width W of a 3-ring binder such as binder 40 is sufficient to enclose a document 10 of standard width W′ of 21.6 cm (8.5 inches) including the additional width of flexible strip 20.

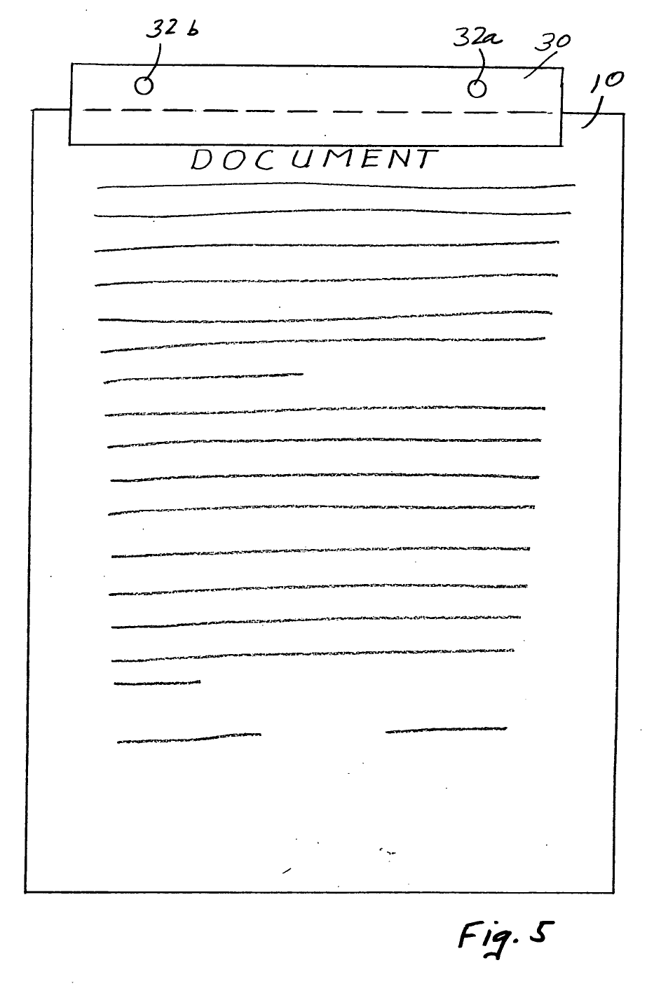

Referring now to FIG. 5, a 2-hole flexible strip 30 is shown assembled to the top edge of document 10. Flexible strip 30 has punched holes 32a and 32b as described above in reference to FIG. 3. With flexible strip 30 assembled to the front surface of document 10, notations regarding document 10 may be written thereon without affecting the integrity of document 10. Mounting flexible 2 hole strip 30 along the top edge of document 10 enables storage of document 10 in a 2 post binder or a folder having 2 flexible tabs.

Whereas the description above included adhesively assembling a flexible strip of the invention to the front surface or to the back surface of a document for storage, it is contemplated that such a flexible strip may be assembled to both front and back surfaces in mirror images so that the holes through the flexible strips are in substantially identical positions. Such a double flexible strip assembly provides greater strength and storage security. Another contemplated variation of the present invention is to strengthen the holes punched through the flexible strip with the addition of reinforcing rings of flexible paper or plastic material.

While the description above discloses preferred embodiments of the present invention, it is contemplated that numerous variations and modifications of the invention are possible and are considered to be within the scope of the claims that follow.

What is claimed is:

1. A document storing aid, comprising a flexible strip with a plurality of holes punched through a first segment thereof and an adhesive coated on a surface of a second segment thereof.

2. The document storing aid described in claim 1, wherein the plurality of holes comprises 3 holes.

3. The document storing aid described in claim 1, wherein the plurality of holes comprises 2 holes.

4. The document storing aid described in claim 1, wherein the adhesive is a releasable, reusable, pressure sensitive adhesive.

5. The document storing aid described in claim 1, wherein the flexible strip is formed of paper.

6. A document storing aid, comprising a flexible strip having a plurality of holes formed therethrough, the holes sized and positioned to engage respective rings of a ring binder or posts of a post binder, and an adhesive coated on a portion of the strip in a segment having no holes.

7. The document storing aid described in claim 6, wherein the flexible strip comprises a paper strip.

8. The document storing aid described in claim 6, wherein the flexible strip comprises a plastic strip.

9. The document storing aid described in claim 6, wherein the adhesive is a releasable, reusable, pressure sensitive adhesive.

10. The document storing aid described in claim 6, wherein the flexible strip comprises a substantially transparent plastic strip.
